(19) United States
(12) Patent Application Publication
(10) Pub. No.: US 2020/0234897 A1
(43) Pub. Date: Jul. 23, 2020

(54) CONTROLLER AND INFORMATION PROCESSING SYSTEM

(71) Applicant: SONY CORPORATION, TOKYO (JP)

(72) Inventors: YOSHIHITO OHKI, TOKYO (JP); TAICHI NOKUO, TOKYO (JP); HIROTAKA TAKO, KANAGAWA (JP); MASAO KONDO, KANAGAWA (JP); YUSUKE TSUJITA, KANAGAWA (JP); YOHEI NAKAJIMA, KANAGAWA (JP); HIROSHI NAKAYAMA, TOKYO (JP); YOSHIYASU KUBOTA, KANAGAWA (JP); DAISUKE SHIONO, TOKYO (JP); MIHO YAMADA, SAITAMA (JP); MASANORI MATSUSHIMA, TOKYO (JP); SEIJI SUZUKI, KANAGAWA (JP); KENICHI YAMAURA, NAGANO (JP)

(21) Appl. No.: 16/485,996

(22) PCT Filed: Dec. 28, 2017
(86) PCT No.: PCT/JP2017/047368

§ 371 Date: Aug. 14, 2019

(30) Foreign Application Priority Data
Feb. 23, 2017 (JP) 2017-032318

(51) Int. Cl. H01H 36/00; H01H 9/16; G08B 7/02

(52) U.S. Cl. CPC H01H 36/0073; H04L 12/282; G08B 7/02; H01H 9/16

(57) ABSTRACT

To provide a controller and an information processing system capable of providing a click feeling and an operation sound with a simpler mechanism. The controller includes a hollow portion, a freely movable first magnet placed in the hollow portion, a second magnet fixed to an outer side of the hollow portion, and a bottom surface having a tilted shape with respect to a ground surface.

### TECHNICAL FIELD

The present disclosure relates to a controller and an information processing system.

### BACKGROUND ART

A structure of a conventional small switch is realized by a pressing drive mechanism mainly using a spring, and a click feeling and an operation sound are provided when a user operates (press, slide, rotate, and the like) an operation unit.

Furthermore, a mechanism for providing a click feeling at the time of a user's operation includes, for example, a rotation movement assisting mechanism having a click mechanism which holds a control target (door, lid of toilet seat, and the like), in an opened state, coupled to a rotation shaft at the time when the rotation shaft reaches a predetermined rotation angle. For example, in Patent Document 1 below, the invention has been proposed which uses an attractive force of a magnet as the click mechanism in such a rotation movement assisting mechanism, has excellent durability, and reduces a sound generated at the time of click.

### CITATION LIST

### Patent Document

Patent Document 1: Japanese Patent Application Laid-Open No. 2002-155925

### SUMMARY OF THE INVENTION

### Problems to be Solved by the Invention

However, all the above configurations require a complicated mechanism, and a shape is restricted, and in addition, it has been difficult to conceal the mechanism from an appearance.

Therefore, according to the present disclosure, a controller and an information processing system capable of providing a click feeling and an operation sound with a simpler mechanism are proposed.

### Solutions to Problems

According to the present disclosure, a controller is proposed which includes a hollow portion, a freely movable first magnet placed in the hollow portion, a second magnet fixed to an outer side of the hollow portion, and a bottom surface having a tilted shape with respect to a ground surface.

According to the present disclosure, an information processing system is proposed which includes a controller including a hollow portion, a freely movable first magnet placed in the hollow portion, a second magnet fixed to an outer side of the hollow portion, and a bottom surface having a tilted shape with respect to a ground surface and a server including a control unit that detects a switching operation of the controller and controls a corresponding external device on the basis of the detected switching operation.

### Effects of the Invention

As described above, according to the present disclosure, it is possible to provide a click feeling and an operation sound with a simpler mechanism.

Note that the above effects are not necessarily limited, and any effect indicated in the present specification or other effect which can be recognized from the present specification may be obtained together with or instead of the above effects.

### BRIEF DESCRIPTION OF DRAWINGS

FIG. 1 is an explanatory diagram of a controller incorporating a switch mechanism according to a first embodiment.

FIG. 2 is an exploded perspective view of the controller incorporating the switch mechanism according to the first embodiment.

FIG. 3 is a front view of a main body configuring the controller according to the first embodiment.

FIG. 4 is a diagram for explaining a switching operation by the controller according to the first embodiment.

FIG. 5 is a diagram for explaining an outline of a usage example of the controller according to the first embodiment.

FIG. 6 is a diagram illustrating an overall configuration of an information processing system according to the present embodiment.

FIG. 7 is a block diagram illustrating an exemplary configuration of a home server according to the present embodiment.

FIG. 8 is a diagram for explaining markers provided on the controller according to the present embodiment.

FIG. 9 is a diagram illustrating an example of a graph indicating a displacement of a movement amount according to the present embodiment.

FIG. 10 is a view for explaining an operation method of a controller having a switch mechanism according to a second embodiment.

FIG. 11 is an exploded perspective view of the controller having the switch mechanism according to the second embodiment.

FIG. 12 is a schematic cross-sectional diagram of the controller having the switch mechanism according to the second embodiment.

FIG. 13 is a diagram for explaining a click feeling and an operation sound generated by a magnet in a rotation operator according to the second embodiment.

FIG. 14 is a diagram for explaining a case where a jug is attached to the controller according to the second embodiment.

FIG. 15 is a diagram illustrating a top view, a front view, and a bottom view of the jug attached to the controller according to the second embodiment.

FIG. 16 is a perspective view of a controller having a switch mechanism according to a third embodiment.

FIG. 17 is a diagram for explaining a usage state of the controller having the switch mechanism according to the third embodiment.

FIG. 18 is a diagram for explaining a movement of a magnet at the time of an operation of the controller according to the third embodiment.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configurations are denoted with the same reference numeral so as to omit redundant description.

Furthermore, the description will be made in the following order.

1. Switch Mechanism According to First Embodiment

1-1. Configuration

1-2. Switching Operation

1-3. Usage Example

2. Switch Mechanism According to Second Embodiment

3. Switch Mechanism According to Third Embodiment

4. Summary

### 1. Switch Mechanism According to First Embodiment

<1-1. Configuration>

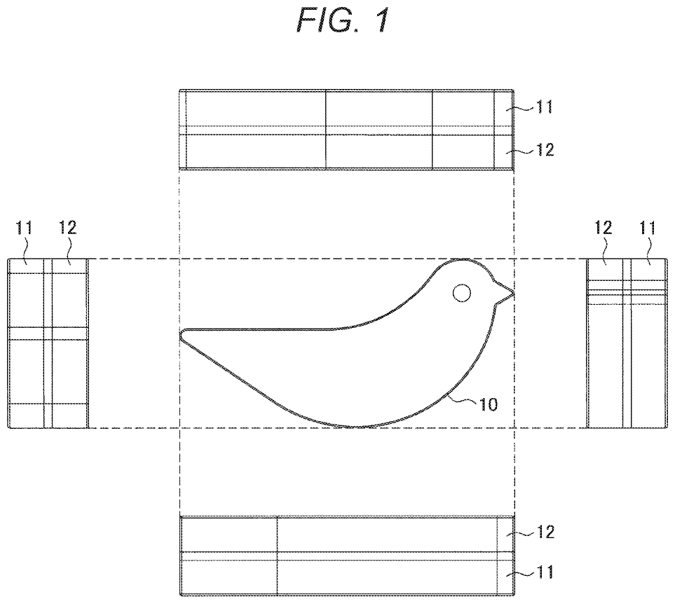

A switch mechanism according to a first embodiment will be described with reference to FIGS. 1 to 4.

FIG. 1 is an explanatory diagram of a controller 10 incorporating a switch mechanism according to the first embodiment. In FIG. 1, a front view of the controller 10 is illustrated in at the center, a top view of the controller 10 is illustrated in an upper portion, a bottom view of the controller 10 is illustrated in a lower portion, a right side view of the controller 10 is illustrated on the right side, and a left side view of the controller 10 is illustrated on the left side. As illustrated in FIG. 1, the controller 10 incorporating the switch mechanism according to the first embodiment has a curved bottom portion and has a semilunar shape or a shape similar to the semilunar shape (in example illustrated in FIG. 1, a bird-like shape as an example). Furthermore, the controller 10 is configured by coupling a main body 12 to a cover 11.

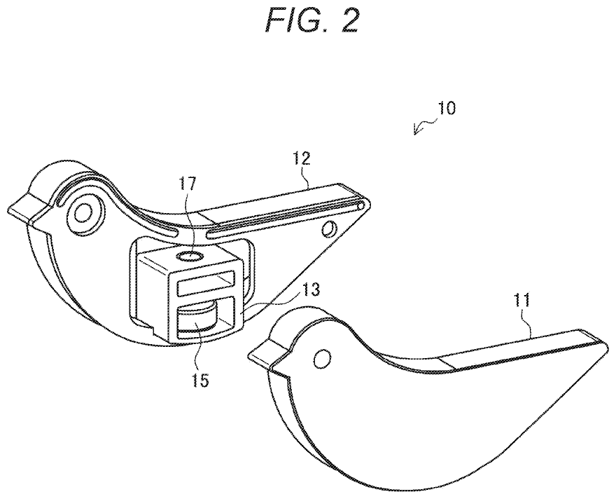

FIG. 2 is an exploded perspective view of the controller 10 incorporating the switch mechanism according to the present embodiment. As illustrated in FIG. 2, a housing 13 forming the switch mechanism according to the present embodiment is provided in the controller 10.

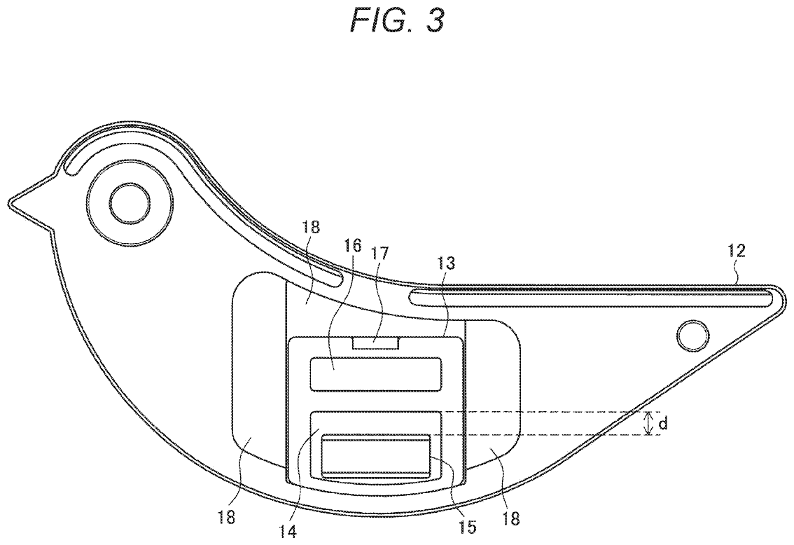

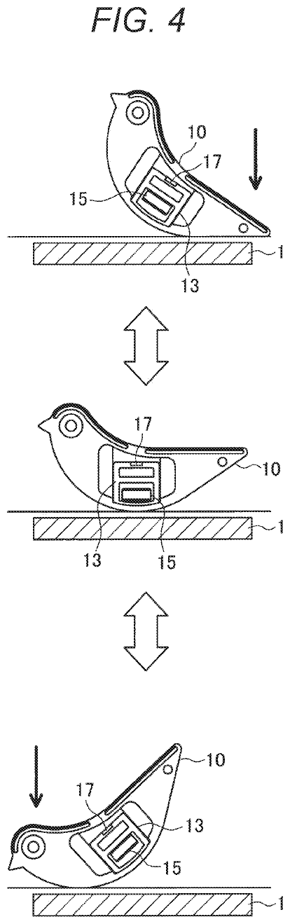

FIG. 3 is a front view of the main body 12 according to the present embodiment. As illustrated in FIGS. 2 and 3, the housing 13 provided in the main body 12 is positioned at the center of gravity of the main body 12, and a hollow portion 14 is provided in the housing 13. A magnet 15 (for example, button-shaped neodymium magnet) is placed in the hollow portion 14 without being fixed and can freely move in the hollow portion 14. The size of the magnet 15 is not particularly limited. However, it is desirable that a gap d between an inner wall surface of the hollow portion 14 and the magnet 15 is within a range where the magnet 15 attracted to a side of a magnet 17 returns to a side of a metal plate 1 at a certain point of time when the controller 10 is returned to a normal state as described later with reference to FIG. 4 (refer to FIG. 4).

Furthermore, the magnet 17 (for example, neodymium magnet) is fixed on the upper portion of the housing 13 (that is, outer side of hollow portion 14). A hollow portion 16 provided between the hollow portion 14 and the magnet 17 has an effect of making a sound echo generated at the time when the magnet 15 moves and collides in the hollow portion 14 (that is, resonance space). However, the housing 13 may have a configuration which does not have the hollow portion 16. Note that the housing 13 includes, for example, a nonmagnetic member such as brass.

Furthermore, as illustrated in FIGS. 2 and 3, by further providing a space 18 (resonance space) around the housing 13, it is possible to echo collision sounds (that is, operation sound at the time of switching operation) of the magnet 15.

Note that, in the examples illustrated in FIGS. 2 and 3, the housing 13 is embedded in the controller 10. However, the present embodiment is not limited to this, and it is possible that the hollow portion 14 is formed in the controller 10, the freely movable magnet 15 is placed in the hollow portion 14, and the magnet 17 is fixed on the outer side of the hollow portion 14.

<1-2. Switching Operation>

Next, a switching operation of the controller 10 having the above configuration will be described with reference to FIG. 4.

As illustrated in FIG. 4, it is assumed that the controller 10 according to the present embodiment be used on a top plate, a wall, a floor, and the like to which the metal plate 1 (magnetic metal member) is attached (may be embedded). In a normal state, as illustrated in the middle portion of FIG. 4, the controller 10 independently stands on a ground surface, and the magnet 15 in the controller 10 is attracted to the side of the metal plate 1, which is close to the magnet 15, in the hollow portion 14.

In the normal state, when a user presses a rear side of the controller 10 (in FIG. 4, side of tail of bird) with a finger from the above, the controller 10 is tilted backward as illustrated in the upper portion in FIG. 4 because a bottom surface is curved. In this case, the housing 13 is separated from the side of the metal plate 1, and the magnet 15 is attracted to the side of the magnet 17 fixed to the upper side of the housing 13 in the hollow portion 14 at a certain point of time. Vibrations and sounds generated when the magnet 15 moves in the hollow portion 14 and is attracted on the inner wall surface are provided to a user as a click feeling and an operation sound.

Then, the user releases the finger which has been pressing the rear side of the controller 10, the controller 10 returns from the backwardly tilted state to a normal state, and the housing 13 approaches to the ground surface. Therefore, the magnet 15 is attracted to the side of the metal plate 1 which is the ground surface in the hollow portion 14. In this way, the magnet 15 moves in the hollow portion 14 and is attracted on the inner wall surface when the controller 10 is returned to the normal state. Therefore, the click feeling and the operation sound are provided to the user.

As described above, the controller 10 according to the present embodiment generates the click feeling and the operation sound each time when the rear side of the controller 10 is pressed with a finger and the controller 10 is tilted and when the finger is released so that the controller 10 is returned to the normal state by its own weight.

Note that, when a front side of the controller 10 (in FIG. 4, side of head of bird) is pressed with a finger from above, a similar action is generated. In other words, when the front side of the controller 10 is pressed to tilt the controller 10 forward, as illustrated in the lower portion in FIG. 4, the magnet 15 in the housing 13 is separated from the side of the metal plate 1 and is attracted to the side of the magnet 17 fixed to the upper portion of the housing 13 at a certain point of time. At this time, the click feeling and the operation sound are provided to the user. Furthermore, when the user releases the finger and the controller 10 returns to the normal state by its own weight, the click feeling and the operation sound are generated.

In the switching operation of the controller 10 according to the present embodiment, one-dimensional discrete values (−1, 0, and 1) can be input according to the normal state (middle portion in FIG. 4), a state where the controller 10 is tilted backward (upper portion in FIG. 4), and a state where the controller 10 is tilted forward (lower portion in FIG. 4).

Furthermore, the controller 10 according to the present embodiment can provide strong feedback (click feeling and operation sound) with respect to the switching operation to the user with a simple structure and without requiring external power.

Furthermore, by combining with a tilt switch or the like which detects inclination (change in gravity acceleration) of the controller 10 and converts the inclination to a switch signal, electrical switching can be performed.

Furthermore, the shape of the bottom surface of the controller 10 is not limited to a semilunar shape (that is, curved surface), and it is sufficient that at least a part of the controller 10 have a tilted shape of which the housing 13 in the controller 10 can be separated from the ground surface (metal plate 2) to a certain extent by pressing the front side or the rear side of the controller 10 from above to tilt the controller 10.

<1-3. Usage Example>

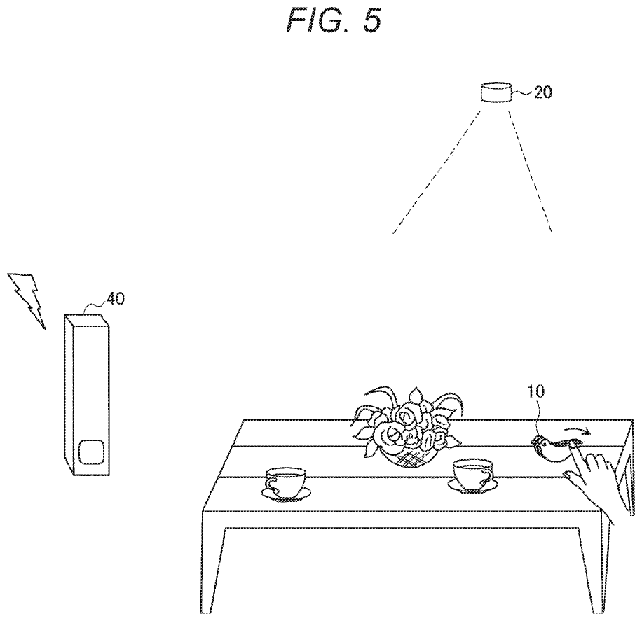

Subsequently, a usage example of the controller 10 will be specifically described with reference to FIGS. 5 to 9.

FIG. 5 is a diagram for explaining an outline of the usage example of the controller 10 according to the first embodiment. As illustrated in FIG. 5, although the controller 10 is placed on, for example, a table and the like, the switch mechanism (mainly housing 13) is concealed in the controller 10. Therefore, the controller 10 can be sufficiently blended into an interior depending on a design of an appearance. Furthermore, for example, it is possible that the controller 10 includes wood and the housing 13 (nonmagnetic member such as brass) is fitted into the controller 10. Note that a metal plate 2 (magnetic metal member) is provided at a place where the controller 10 is placed (for example, metal plate 2 may be embedded in a top plate of table or controller 10 may be placed on metal plate (not illustrated) provided on table).

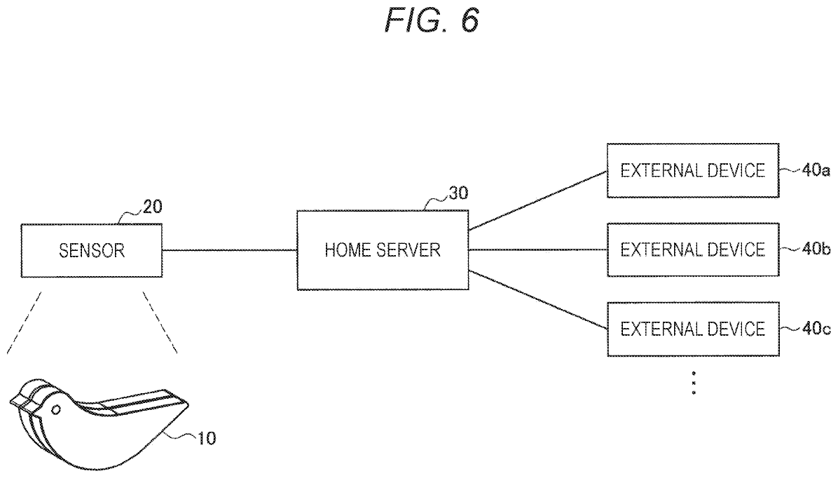

Here, when the user operates to press the front side or the rear side of the controller 10 from above with a finger so as to tilt the controller 10, the movement of the magnet 15 in the controller 10 can provide a click feeling and an operation sound. The movement of the controller 10 (tilting operation) is detected by a sensor 20 provided around the controller 10 is detected by a home server 30 (refer to FIG. 6) as a switching operation. The home server 30 controls a corresponding external device on the basis of the detected switching operation. Contents of external device control is not particularly limited. However, for example, the home server 30 may control (reproduce, skip, stop, and the like) of a stand-type speaker (external device 40) as illustrated in FIG. 5.

An overall configuration of an information processing system according to the present embodiment is illustrated in FIG. 6. As illustrated in FIG. 6, the home server 30 is connected to the sensor 20 and various external devices 40 (40a to 40c).

The sensor 20 is, for example, an infrared camera. The sensor 20 detects a marker provided on the controller 10 and outputs the detection result (infrared image) to the home server 30.

The external devices 40a to 40c are devices to be controlled by the home server 30. For example, a speaker (audio system), a television, a projector, a recorder, an air conditioner, an illumination device, an electric curtain device, and the like are assumed as the external device 40.

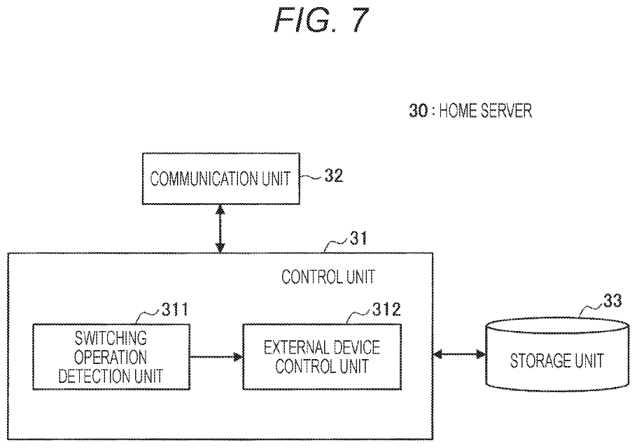

The home server 30 detects a switching operation on the basis of the detection result detected by the sensor 20 and controls the external devices. Here, in FIG. 7, an exemplary configuration of the home server 30 is illustrated.

As illustrated in FIG. 7, the home server 30 includes a control unit 31, a communication unit 32, and a storage unit 33.

The control unit 31 functions as a calculation processing device and a control device and controls a general operation in the home server 30 according to various programs. The control unit 31 is realized by, for example, an electronic circuit such as a Central Processing Unit (CPU) and a microprocessor. Furthermore, the control unit 31 may include a Read Only Memory (ROM) which stores a program to be used, a calculation parameter, and the like and a Random Access Memory (RAM) which temporarily stores a parameter which appropriately changes and the like.

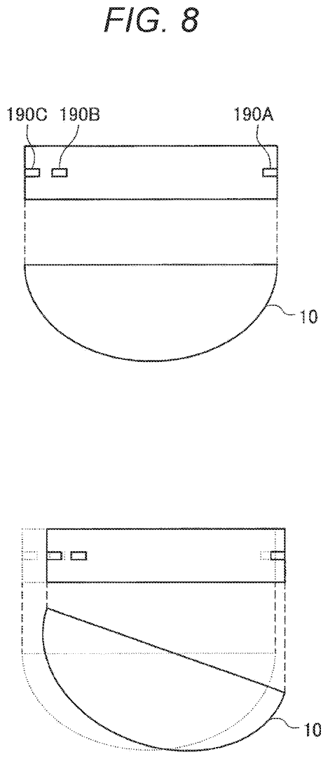

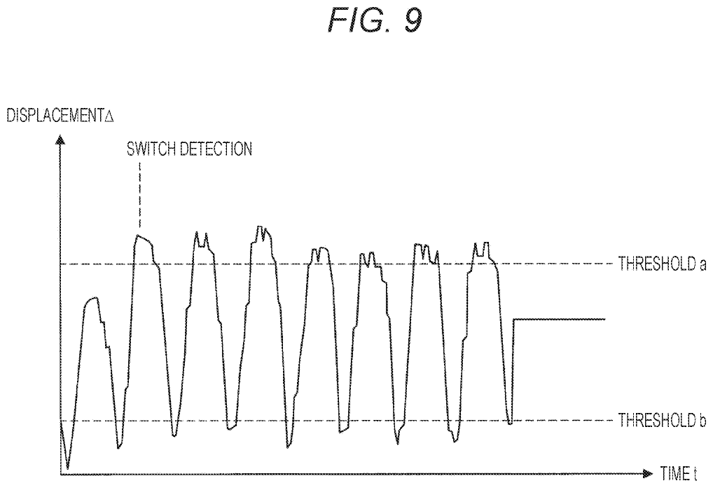

Furthermore, the control unit 31 according to the present embodiment functions as a switching operation detection unit 311 and an external device control unit 312. The switching operation detection unit 311 analyzes the detection result (infrared image) output from the sensor 20 and determines whether or not a switch is pressed. Specifically, for example, on the top surface of the controller 10, a plurality of markers including a retroreflective material is attached along a straight line as illustrated in FIG. 8. One marker (marker 190A) is provided on one side, and two markers (markers 190B and 190C) are provided on the other side. The switching operation detection unit 311 analyzes the infrared image imaged by the sensor 20 from the upper side of the controller 10 on which the markers 190A to 190C are provided and determines a direction in which the controller 10 is pressed. Specifically, as illustrated in the lower portion in FIG. 8, when the controller 10 is pressed, positions of the markers 190A to 190C are moved. Therefore, in a case where the switching operation detection unit 311 detects the positions of the markers 190A to 190C (bright spot) and tracks the movement direction and the movement amount and the movement directions of the respective bright spots in a certain period of time are substantially the same and a displacement exceeds a certain amount, the switching operation detection unit 311 determines that the switch has been pressed. Here, in FIG. 9, an example of the displacement of the detected movement amount according to the present embodiment is illustrated.

As illustrated in FIG. 9, in a case where the minimum value of the displacement falls below a threshold b, and the maximum value of the displacement exceeds a threshold a, and in addition, a time lapse between the minimum value and the maximum value is within a certain period of time, the switching operation detection unit 311 determines that the switch has been pressed.

Alternatively, in a case where the maximum value of the displacement exceeds the threshold a and the time elapse between the maximum value and the next maximum value is within a certain period of time, the switching operation detection unit 311 may determine that the switch has been pressed.

The external device control unit 312 controls the corresponding external device in response to the switching operation detected by the switching operation detection unit 311. Specifically, the external device control unit 312 transmits a control signal from the communication unit 32 to a target external device.

The communication unit 32 wiredly or wirelessly connected and communicated with the sensor 20 and the external devices 40a to 40c and exchanges data with the sensor 20 and the external devices 40a to 40c. Furthermore, for example, the communication unit 32 uses a wired or wireless Local Area Network (LAN), Wireless Fidelity (Wi-Fi, registered trademark), Bluetooth (registered trademark), or the like.

The storage unit 33 is realized by the ROM which stores the program, the calculation parameter, and the like used for processing by the control unit 31 and the RAM which temporarily stores the parameter and the like which appropriately changes.

### 2. Switch Mechanism According to Second Embodiment

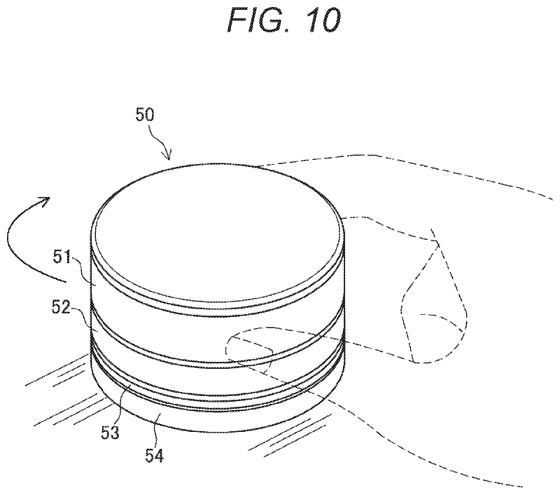

Next, a switch mechanism according to a second embodiment will be described with reference to FIGS. 10 to 13. FIG. 10 is a diagram for explaining an operation method of a controller 50 having the switch mechanism according to the second embodiment. As illustrated in FIG. 10, the controller 50 is formed in a cylindrical shape including a rotation operator 51, a support 52, a magnet plate 53, and an anti-slip member 54.

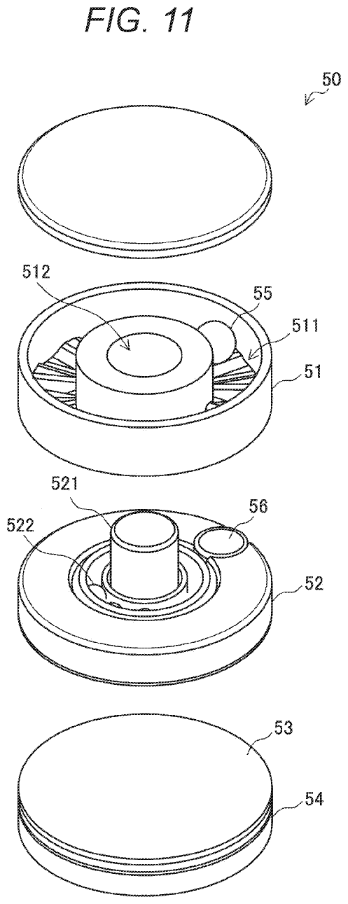

A user pinches the rotation operator 51 with fingers and rotates the rotation operator 51 clockwise or counterclockwise. At this time, a spherical magnet 55 in the rotation operator 51 (refer to FIG. 11) passes over a peak formed on a rail in the controller 50, and vibrations and sounds generated at that time are provided as a click feeling and an operation sound.

FIG. 11 is an exploded perspective view of the controller 50 having the switch mechanism according to the present embodiment. As illustrated in FIG. 11, the rotation operator 51 has a through-hole 512, through which a shaft 521 of the support 52 passes, at the center, and series of peaks and troughs are provided on a bottom portion of an annular rail 511 formed around the through-hole 512. Furthermore, the spherical magnet 55 (for example, neodymium magnet) which is not fixed and can freely move is placed in the rail 511. The magnet 55 attracts a magnet 56 of the support 52. Note that a material of the rotation operator 51 is not particularly limited. However, for example, the rotation operator 51 may include an ABS resin.

The support 52 has the shaft 521 at the center, a bearing 522 is provided around a base of the shaft, and the magnet 56 (for example, neodymium magnet) is fixed to a part of an annular region around the bearing 522. The shaft 521 may be a magnet (magnetic member) or a nonmagnetic member such as brass.

On a top surface of the anti-slip member 54 (for example, anti-slip rubber material), the magnet plate 53 (for example, neodymium plate magnet) is provided. Both of the anti-slip member 54 and the magnet plate 53 are provided to fix the support 52 at the time of the rotation operation. In the example illustrated in FIG. 11, the controller 50 has the configuration including the anti-slip member 54 and the magnet plate 53. However, the controller 50 according to the present embodiment may have a configuration having only one of the anti-slip member 54 and the magnet plate 53. For example, in a case where the controller 50 can be sufficiently fixed by frictional force of the anti-slip member 54, the magnet plate 53 is unnecessary.

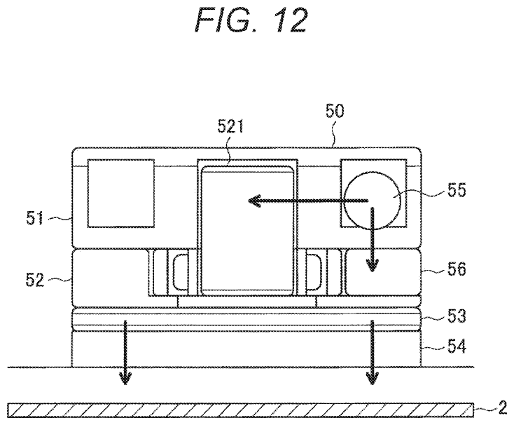

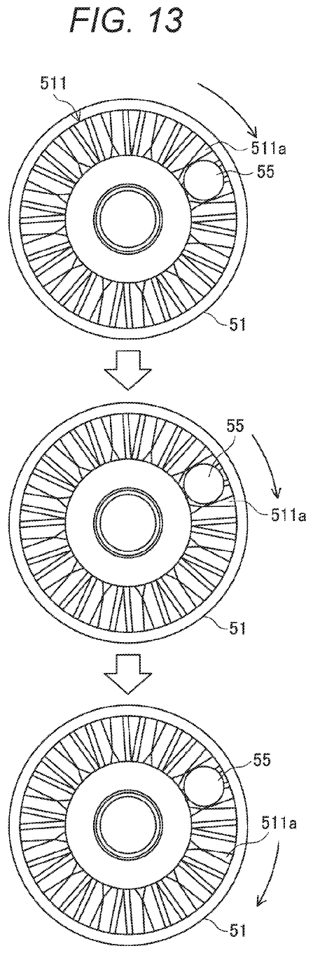

FIG. 12 is a schematic cross-sectional diagram of the controller 50 having the switch mechanism according to the present embodiment. As illustrated in FIG. 12, the magnet 55 in the rotation operator 51 is attracted by the magnet 56 fixed to the support 52 positioned in the lower portion. Therefore, even when the rotation operator 51 rotates and the rail 511 moves, the magnet 55 can moves over the peaks of the rail 511, be attracted by the magnet 56, and stay at a certain position. Collision and vibration caused at the time when the magnet 55 moves over the peak provide a click feeling and an operation sound. Here, in FIG. 13, a diagram for explaining the click feeling and the operation sound generated by the magnet 55 is illustrated.

As illustrated in FIG. 13, when a user pinches the rotation operator 51 to rotate the rotation operator 51 in the right direction, the rail 511 moves in the right direction. However, since the magnet 55 is attracted by the magnet 56 arranged in the lower portion, a movement moving over a peak 511a and staying at the position is caused. In this way, collision and vibration caused when the magnet 55 moves over the peak 511a of the rail 511 are provided to the user as the click feeling and the operation sound.

Note that, depending on magnetic forces of the magnets 55 and 56, a shape (size) of the peak, and the like, there is a case where the magnet 56 cannot stay at the position and moves together with the rail 511. In this case, by forming the shaft 521 by using a magnetic member and adjusting the magnetic force and the shape of the peak, as illustrated in FIG. 12, according to actions of vertical magnetic force relative to the magnet 56 and horizontal magnetic force relative to the shaft 521, it is possible to more firmly hold the magnet 55 at a certain position.

Furthermore, the magnet plate 53 attracts the metal plate 2 embedded in a table and the like so as to fix the controller 50 to the table and the like.

As described above, the vibration and the sound caused at the time when the magnet 55 in the controller 10 moves over the peak of the rail 511 by rotating the rotation operator 51 of the controller 10 are provided as a feeling of the operation and the operation sound. For example, when the rotation operator 51 is continuously rotated, the magnet 55 sequentially moves over the peaks, and the user can obtain a click feeling each time when the magnet 55 moves over the peak. As in the first embodiment, such a rotation operation can be detected by the home server 30 by imaging the marker (not illustrated) provided on the top surface of the controller 50 by an infrared camera. A switching operation detection unit 311 of the home server 30 can analyze the infrared image, detect a bright spot based on the marker provided on the top surface of the controller 50, track a movement direction and a movement amount of the bright spot, and detect a switching operation.

Furthermore, it is possible to collect the operation sound generated at the time of the switching operation by a microphone and detect the switching operation on the basis of the operation sound by the switching operation detection unit 311 of the home server 30. Furthermore, it is possible that a magnetic change of the controller 50 caused by the switching operation is detected by a geomagnetic sensor provided around the controller 50 (provided in communication terminal such as smartphone placed around) and the switching operation is detected on the basis of the magnetic change by the switching operation detection unit 311 of the home server 30.

Furthermore, it is possible to detect the switching operation by combining at least any one of the infrared image, the operation sound, and the magnetic change described above.

Furthermore, in an information processing system according to the present embodiment, a projector may project an operation guidance image (volume adjustment image and the like) around the controller 50 placed on the table and the like. By feeding back the detected operation of the controller 50 to the operation guidance image, a user can perform an operation while confirming operation contents.

(Application Example)

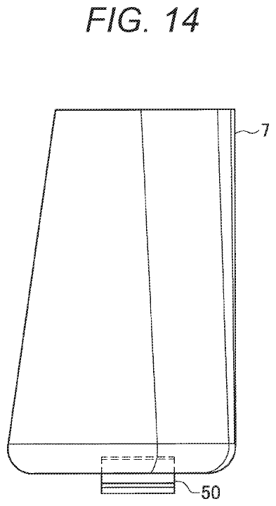

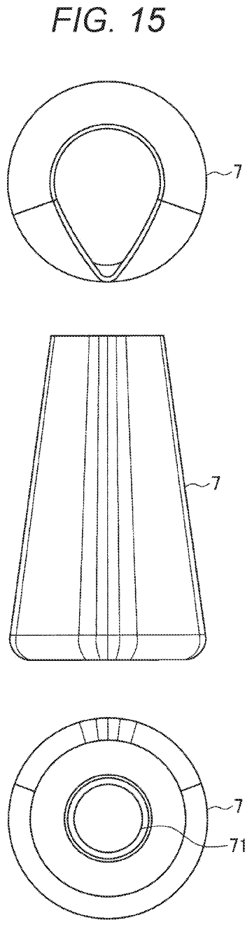

As an application example of the rotation-operation-type controller 50 described above, an interior product (object) such as a jug can be attached to the controller 50. FIG. 14 is a diagram for explaining a case where a jug 7 is attached to the controller 50. As illustrated in FIG. 14, for example, by fitting the controller 50 into a bottom portion of the jug 3 and rotating the jug 7, it is possible to rotate the rotation operator 51 of the controller 50 and perform a switching operation. FIG. 15 is a diagram illustrating a top view, a front view, and a bottom view of the jug 7. As illustrated in FIG. 15, by providing a recess 71 in a bottom surface of the jug 7, the rotation operator 51 of the controller 50 can be fitted into the recess 71. Furthermore, by providing such a recess 71, it is possible to similarly attach the controller 50 to any object.

### 3. Switch Mechanism According to the Third Embodiment

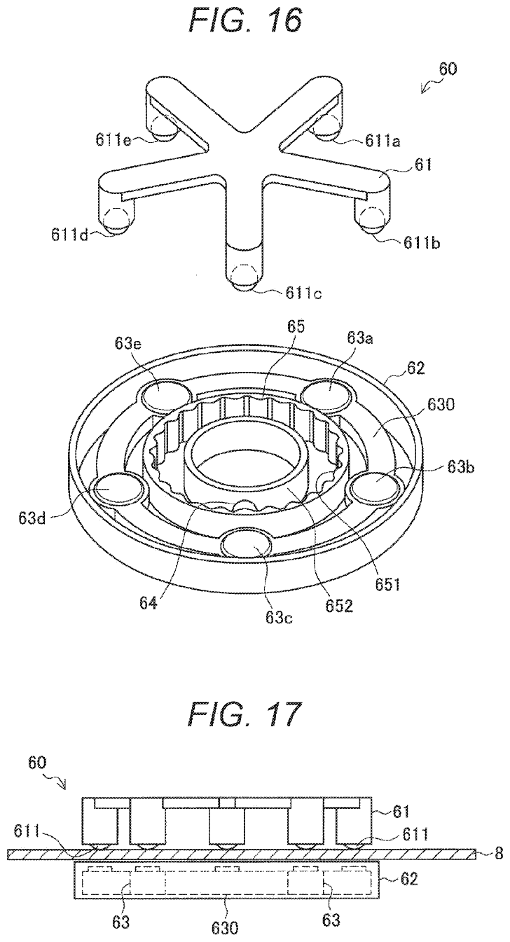

Subsequently, a switch mechanism according to a third embodiment will be described with reference to FIGS. 16 to 18. FIG. 16 is a perspective view of a controller 60 having a switch mechanism according to the third embodiment. The controller 60 includes an operation member 61 which is placed on a table and the like and is operated by a user and a unit 62 attached below (or inside) the table and the like.

The operation member 61 has a plurality of legs (for example, equal to or more than three), and a magnet 611 (for example, spherical magnet neodymium) is fixed to the front end of each leg.

The unit 62 includes an annular member 630 in which a plurality of magnets 63 (for example, neodymium magnet) is provided and an annular rail 65 inside the annular member 630, and a wave shape is provided on a first inner side surface 651 of the rail 65. In the rail 65, a spherical magnet 64 (for example, spherical magnet neodymium) is placed between the first inner side surface 651 and a second inner side surface 652. The multiple magnets 63a to 63e provided in the annular member 630 respectively correspond to magnets 611a to 611e provided at the front ends of the legs of the operation member 61 and are arranged to be attracted by the magnets 611a and 611e having a table and the like therebetween. Furthermore, the annular member 630 is not fixed and can circumferentially rotate.

FIG. 17 is a diagram for explaining a usage state of the controller 60 having the switch mechanism according to the present embodiment. As illustrated in FIG. 17, for example, when the unit 62 is fixed below a table 8 and the operation member 61 is placed on the table 8, the plurality of magnets 611 provided at the front end of the leg of the operation member 61 corresponds to and is attracted by the plurality of magnets 63 provided in the annular member 630 in the unit 62 fixed below the table 8. Note that the number of magnets 611 provided in the operation member 61 is not particularly limited. However, for example, when three or more magnets are provided so as to form a rotation shaft and an operation for circumferentially rotating the operation member 61 is performed, an attracted state is easily maintained.

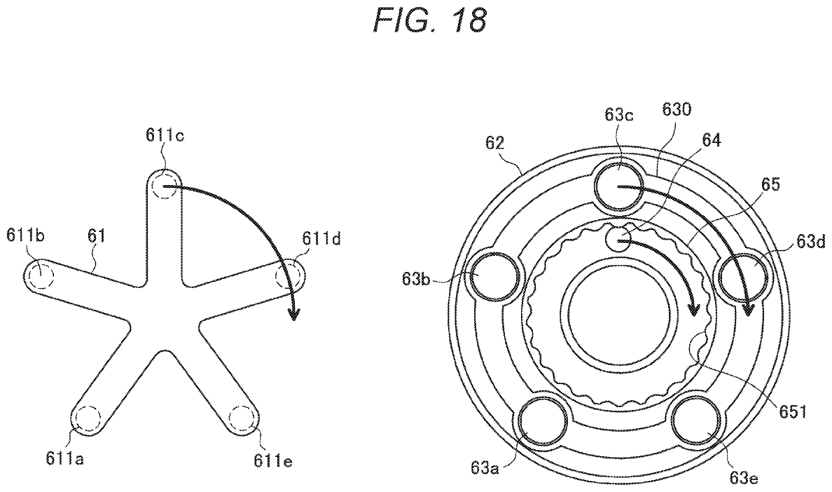

Subsequently, a movement of the magnet 64 at the time when the controller 60 is operated will be described with reference to FIG. 18. As illustrated on the left side in FIG. 18, a user performs an operation for circumferentially rotating the operation member 61 clockwise or counterclockwise. In response to the rotation of the operation member 61, the magnets 63a to 63e provided in the annular member 630 of the unit 62 are pulled by the magnets 611a to 611c provided at the front ends of the legs of the operation member 61, and the annular member 630 circumferentially rotates similarly to the above movement. At this time, for example, the magnet 64 in the rail 65 is pulled in a state of being attracted by the magnet 63c as illustrated in FIG. 18 and moves in the rail 65. At this time, since the magnet 64 moves over the wave shape provided on the first inner side surface 651, collision and vibration of the magnet 64 on the first inner side surface 651 generate the click feeling and the operation sound of the switching operation.

### 4. Summary

As described above, the controller according to the embodiments of the present disclosure can provide a click feeling and an operation sound with a simpler mechanism.

Preferred embodiments of the present disclosure have been described in detail above with reference to the drawings. However, the present technology is not limited to the examples. It is obvious that a person who has normal knowledge in the technical field of the present disclosure can arrive at various variations and modifications in the scope of the technical ideas described in claims. It is understood that the variations and modifications naturally belong to the technical scope of the present disclosure.

For example, a computer program for causing hardware such as a CPU, a ROM, and a RAM built in the home server 30 described above to function as the home server 30 can be created. Furthermore, a computer-readable storage medium storing the computer program is provided.

Furthermore, the effects described in the present description are merely illustrative and exemplary and not limited. That is, the technology according to the present disclosure can exhibit other effects obvious to those skilled in the art from the description in the present specification together with or instead of the above described effects.

Note that, the present technology can have the configuration below.

(1)

A controller including:

a hollow portion;

a freely movable first magnet placed in the hollow portion;

a second magnet fixed to an outer side of the hollow portion; and

a bottom surface having a tilted shape with respect to a ground surface.

(2)

The controller according to (1), in which

the first magnet

attracts a magnetic metal member arranged on the ground surface and generates vibration and a collision sound when approaching to the ground surface, and

attracts a side of the second magnet and generates vibration and a collision sound when the bottom surface is tilted and is separated from the ground surface.

(3)

The controller according to (2), in which

a separation distance between the first magnet and the hollow portion is within a range in which the first magnet is capable of returning to the side of the magnetic metal member arranged on the ground surface from a state where the first magnet is attracted to the side of the second magnet in the hollow portion when the first magnet approaches to the ground surface.

(4)

The controller according to any one of (1) to (3), in which

the first magnet includes a button-shaped neodymium magnet.

(5)

The controller according to any one of (1) to (4), in which

the hollow portion includes a nonmagnetic member.

(6)

The controller according to (2), in which

a resonance space for further resonating the collision sound is provided around the hollow portion.

(7)

The controller according to any one of (1) to (6), in which

a marker to be read by an infrared sensor so as to detect a switching operation of the controller is provided on a top surface of the controller.

(8)

An information processing system including:

a controller including:

a hollow portion;

a freely movable first magnet placed in the hollow portion;

a second magnet fixed to an outer side of the hollow portion; and

a bottom surface having a tilted shape with respect to a ground surface; and

a server including:

a control unit that detects a switching operation of the controller and controls a corresponding external device on the basis of the detected switching operation.

### REFERENCE SIGNS LIST

10 Controller
11 Cover
12 Main body
13 Housing
14 Hollow portion
15 Magnet
16 Hollow portion
17 Magnet
18 Space
20 Sensor
30 Home server
31 Control unit
311 Switching operation detection unit
312 External device control unit
32 Communication unit
33 Storage unit
40a to 40c External device
50 Controller
51 Rotation operator
511 Rail
511a Peak
512 Through-hole
52 Support
521 Shaft
522 Bearing
53 Magnet plate
54 Anti-slip member
55 Magnet
56 Magnet
60 Controller
61 Operation member
611 (611a to 611e) Magnet
62 Unit
63 (63a to 63e) Magnet
64 Magnet
65 Rail
651 First inner side surface
652 Second inner side surface
630 Annular member

1. A controller comprising:
a hollow portion;
a freely movable first magnet placed in the hollow portion;
a second magnet fixed to an outer side of the hollow portion; and
a bottom surface having a tilted shape with respect to a ground surface.

2. The controller according to claim 1, wherein
the first magnet
attracts a magnetic metal member arranged on the ground surface and generates vibration and a collision sound when approaching to the ground surface, and
attracts a side of the second magnet and generates vibration and a collision sound when the bottom surface is tilted and is separated from the ground surface.

3. The controller according to claim 2, wherein
a separation distance between the first magnet and the hollow portion is within a range in which the first magnet is capable of returning to the side of the magnetic metal member arranged on the ground surface from a state where the first magnet is attracted to the side of the second magnet in the hollow portion when the first magnet approaches to the ground surface.

4. The controller according to claim 1, wherein
the first magnet includes a button-shaped neodymium magnet.

5. The controller according to claim 1, wherein
the hollow portion includes a nonmagnetic member.

6. The controller according to claim 2, wherein
a resonance space for further resonating the collision sound is provided around the hollow portion.

7. The controller according to claim 1, wherein
a marker to be read by an infrared sensor so as to detect a switching operation of the controller is provided on a top surface of the controller.

8. An information processing system comprising:
a controller including:
a hollow portion;
a freely movable first magnet placed in the hollow portion;
a second magnet fixed to an outer side of the hollow portion; and
a bottom surface having a tilted shape with respect to a ground surface; and
a server including:
a control unit that detects a switching operation of the controller and controls a corresponding external device on a basis of the detected switching operation.
